(19) United States
(12) Patent Application Publication
(10) Pub. No.: US 2022/0411107 A1
(43) Pub. Date: Dec. 29, 2022

(54) METHOD FOR CONTROLLING A PLURALITY OF CONTROL STATIONS OF AN AIRCRAFT AND ASSOCIATED CONTROL SYSTEM

(71) Applicant: AIRBUS HELICOPTERS, Marignane Cedex (FR)

(72) Inventors: Stephane DUPUY, Senas (FR); Michel DEPARIS, Martigues (FR)

(73) Assignee: AIRBUS HELICOPTERS, Marignane Cedex (FR)

(21) Appl. No.: 17/841,266

(22) Filed: Jun. 15, 2022

(30) Foreign Application Priority Data
Jun. 29, 2021 (FR) 2106987

(51) Int. Cl. B64F 5/60; G06F 3/0482; G06T 7/30

(52) U.S. Cl. CPC B64F 5/60; G06F 3/0482; G06T 7/30; G06T 2200/24

(57) ABSTRACT

A method and a system for controlling a plurality of control stations of an aircraft. The control method comprises determining a current position of a portable electronic terminal in relation to the aircraft, identifying a current control station, determining at least one current image of the aircraft representative of the current control station, displaying, on a screen of the portable electronic terminal, the at least one current image, displaying at least one graphic interface component in overlay on the at least one current image, selecting a result relating to an inspection of at least one component on the portable electronic terminal and storing it in a memory, the result corresponding to a validated state or a non-validated state of the at least one inspected component.

### CROSS REFERENCE TO RELATED APPLICATIONS

This application claims priority to French patent application No. FR 21 06987 filed on Jun. 29, 2021, the disclosure of which is incorporated in its entirety by reference herein.

### TECHNICAL FIELD

The present disclosure relates to a method and a system for controlling a plurality of control stations of an aircraft. Such a control station may, for example, consist of an area or a part of the aircraft comprising at least one component to be inspected by an operator.

### BACKGROUND

Indeed, such a control method must be performed on a regular basis on an aircraft on the ground, for example every ten flight hours, in order to maintain an optimal level of safety during flight phases. Such a control method may be performed, for example, by a technician or indeed by a pilot of the aircraft and consists in inspecting various areas of the aircraft such as, for example, a part of the fuselage, aerodynamic components forming a fixed wing or tail unit, a rotorcraft rotor, a landing gear, a propeller, an engine, etc.

Each of these areas of the aircraft thus forms a control station that may have one or more components to be controlled.

Generally, known control methods consist in using a manual of the aircraft presenting the different control stations and the components to be inspected. The operator conducts a survey of the aircraft with this manual and, as appropriate, searches the pages of this manual for the problems that he or she may encounter and the different components to be checked.

Document US 2018/232132A1 describes a system for displaying different components of an aircraft in three dimensions in order to train a technician in a control method.

However, such a system is virtual and does not directly use the aircraft. Therefore, such a system may offer limited intuitiveness in terms of inspecting components of an aircraft.

Alternatively, document US 2018/118376A1 describes a method for performing a quick control prior to each flight phase of an aircraft by using a portable electronic device. Such a portable electronic device can communicate remotely with a plurality of sensors in order to check that the aircraft can carry out this flight phase.

Moreover, such a method is not designed to enable an operator to visually control components of the aircraft to be inspected.

Document US 2007/010923 describes a diagnostic tool for repairing airplanes and a method using this tool.

An inspector 4 is equipped with a portable electronic device comprising display means and an electronic memory. This device may be a graphic tablet having an interactive screen.

A graphic tablet also incorporates wireless communication means. In order to enable the graphic tablet to communicate with a network, the area for inspecting the airplane is equipped with terminals 6 coupled to an Ethernet network 12. The information collected by the inspector 4 during the inspection of the airplane 2 is sent by the transmission means of the graphic tablet to a technical team of the airline.

The inspector 4, who is tasked with examining the airplane 2 in detail, uses his or her graphic tablet to provide all the information necessary in order to take a decision with respect to the damage he or she has just discovered. Moreover, a memory of the graphic tablet may incorporate a computer model of the airplane 2 being examined. Naturally, viewing software is installed on the graphic tablet.

The graphic tablet also incorporates the repair manual (SRM) 20 of the airplane 2 in question. This manual (SRM) is associated with a database of repairs. The characteristics of the recorded damage are indicated on a report (DRS). The various known reports (DRS) of the airline may also be stored in the memory of the graphic tablet.

FIG. 2 shows a screen 22 of a graphic tablet. In the embodiment shown, this screen has a central graphic zone 24 around which two columns and a title bar are arranged. Thus, to the left of the graphic zone 24, the various ATA (standing for Air Transport Association) chapters defining each part of an airplane are mentioned in a first column 26.

In order to compile his or her report, the inspector 4 chooses the ATA chapter concerned by the damage. A scroll bar allows navigation through the list of chapters and sub-chapters. The various parts concerned by this chapter and sub-chapter are then displayed on a large-scale diagram in the central graphic zone 24. The different parts can be distinguished on account of their being displayed in a different color from the rest of the diagram, for example.

Document U.S. Pat. No. 7,050,894 relates to a method and a device for diagnosing the condition of aircraft components or assemblies of aircraft components in order to provide maintenance and repair information.

A maintenance agent M is equipped with a portable signal processing unit 6 that belongs to a diagnostic system 2 and allows communication with at least one state sensor 8 designed individually for each component or assembly of components that needs to be monitored and diagnosed.

The mechanic may, for example, touch any particular coordinate point on the display screen 10 with a pencil P in order to interrogate the respective sensor 8 that is, for example, positioned to monitor a hydraulic container 12. A signal is transmitted T wirelessly from a transceiver 11 to the transceiver of the sensor 8 over a range or distance of at least 12 meters.

Moreover, document U.S. Pat. No. 9,600,944 describes an aircraft auditing system. This system makes it possible to automatically calculate a fuel penalty on the basis of aerodynamic faults detected on the audited aircraft.

### SUMMARY

Such a system comprises, in particular, a portable computer device with an interactive screen. The object of the present disclosure is therefore to propose an alternative control method that helps overcome the above-mentioned limitations. Moreover, the implementation of such a control method is highly intuitive, and the control system therefore offers optimal ergonomics.

The disclosure therefore relates to a method for controlling a plurality of control stations of an aircraft, each control station comprising at least one component to be inspected by an operator.

According to the disclosure, such a control method is remarkable in that it comprises the following steps:

determining a current position of a portable electronic terminal in relation to the aircraft, the portable electronic terminal being carried by the operator;

identifying, with the portable electronic terminal, a current control station from the plurality of control stations, said identification depending on the current position of the portable electronic terminal in relation to the aircraft;

determining at least one current image of the aircraft representative of the current control station; displaying, on a screen of the portable electronic terminal, the current image or images of the aircraft;

displaying, on the screen, at least one graphic interface component corresponding to said at least one component to be inspected of the current control station, the graphic interface component or components being displayed in overlay on the current image or images; and selecting a result relating to an inspection of the component or components on the portable electronic terminal, and storing it in a memory, the result corresponding to a validated state or a non-validated state of the inspected component or components.

In other words, such a control method is implemented by the operator using the portable electronic terminal and moving all the way around the aircraft from control station to control station. Preferably, the operator may follow a predefined path, for example following a numerical order of the different control stations.

This control method therefore helps improve the reliability of the visual control of the components of an aircraft to be inspected, and may be used directly by a trained operator or be used for training the operator.

Such a method therefore makes it possible to automatically identify a current control station based on a current position of the portable electronic terminal in relation to the aircraft. The current control station may be identified directly by the portable electronic terminal without any manual action being taken by an operator, for example depending on the distance separating the portable electronic terminal from this control station on the aircraft.

Moreover, areas may also be delimited around the whole aircraft and each area may then correspond to at least one control station.

Once the current control station has been automatically identified by the portable electronic terminal, the method allows one or more current images of the aircraft corresponding to this current control station to be displayed. Such current images may, for example, be acquired in advance and stored or indeed acquired in real time.

The graphic interface component or components are then overlaid on the current image or images in order to indicate to the operator, directly on at least one image from the current image or images, the component or components to be inspected. Such an overlaying operation thus helps make controlling the components of the aircraft intuitive and facilitate identification of the component or components to be inspected of the current control station. Indeed, the operator sees a three-dimensional or perspective view on the screen of the component that he or she needs to inspect on the aircraft, for example with a particular contour color delimiting this component on the current image or images.

A three-dimensional model of the aircraft is thus generated in advance and stored. This three-dimensional model comprises a set of graphic interface components such as contours delimiting, for example, a shape, an area, a volume, etc.

Such graphic interface components are displayed in a particular color that is visible in overlay on a current image. The graphic interface components may also be displayed, for example, by generating a flashing effect or any other effect helping to highlight an area of the image comprising the component to be inspected.

Moreover, the portable electronic terminal carried by the operator may be a one-piece device and is, for example, formed by a computer, a tablet having a touch panel, a helmet or an equivalent or indeed a smartphone.

According to one alternative of the disclosure, the portable electronic terminal carried by the operator may also be formed by several separate parts. For example, such a portable electronic terminal may therefore comprise a remote screen close to the operator's eyes such as, for example, on a helmet, a visor or indeed a pair of glasses, and a central unit carried, for example, in the operator's hand or in a garment pocket.

Advantageously, the control method may comprise the following steps:

determining and displaying, on the screen, at least one instruction corresponding to said at least one component to be inspected of the current control station, another memory storing, for each component, one or more instructions; and selecting the instruction or instructions, by means of the portable electronic terminal, by the operator.

In other words, the control method allows the operator to be reminded of all the inspection instructions corresponding to the inspected component. The portable electronic terminal is therefore used used both to display a list corresponding to the different instructions on the screen and to choose one of the instructions from this list to be displayed in detail, for example next to the current image.

The memory storing the result of each inspection and the other memory storing the inspection instructions may optionally form a one-piece assembly and correspond to different storage areas of this one-piece assembly.

In practice, for each of the instructions, the control method may comprise the following steps:

determining a piece of state data representative of a current state of each instruction of said at least one inspected component, the current state being chosen from the group comprising an instruction validated state, an instruction not validated state, an instruction forgotten state and an instruction not carried out state;

storing the piece of state data; and

displaying the piece of state data on the screen.

For example, such a piece of state data may be displayed by using a predetermined color code. According to one embodiment, the color of a background displayed at each of the instructions may vary depending on the piece of state data.

Therefore, when the current state of an instruction is the instruction validated state, the background color of this instruction may be green. When the current state of an instruction is the instruction not validated state, the background color of this instruction may be red.

When the current state of an instruction is the instruction forgotten state, the background color of this instruction may be orange. Such a current state may be displayed when the operator skips an instruction without validating it or declaring it non-validated.

When the current state of an instruction is the instruction not carried out state, the background color of this instruction may be blue.

When the current state of an instruction is the instruction not validated state, the operator may possibly need to fill in a form with the name of the non-validated component or components. Once the form has been filled, the control method may automatically move on to the next instruction that has an instruction not carried out state or an instruction forgotten state of a component to be inspected.

As long as the current state of at least one instruction of a component to be inspected is at the instruction not validated state, the instruction not carried out state or the instruction forgotten state, the result relating to the inspection of this component corresponds to a non-validated state.

However, when all the instructions of a component to be inspected are at the instruction validated state, the result relating to the inspection of this component corresponds to a validated state.

Thus, the selection of the result corresponding to a validated state of the inspected component may be implemented automatically when all the instructions of this component are at the instruction validated state.

According to a first operating mode, the control method may comprise selecting a virtual reality operating mode, the determination of the current image or images of the aircraft being carried out by selecting the current image or images from a plurality of stored images of the aircraft.

In other words, the current images displayed on the portable electronic terminal are images of the aircraft acquired in advance and then stored in a memory that may advantageously be totally or partially embedded in the portable electronic terminal.

According to a second operating mode implemented additionally or alternatively, the control method may comprise selecting an augmented reality operating mode, the determination of at least one current image of the aircraft being carried out by means of a camera integrated into the portable electronic terminal.

In this case, the current images displayed on the portable electronic terminal are acquired by the camera and then displayed directly on the screen. The images may optionally be stored, but this is not obligatory in this augmented reality operating mode.

Moreover, the graphic interface component or components are then calculated in real time based on a predetermined model and in order to be able to be displayed in overlay on the current image or images. For example, the graphic interface component or components of the model may undergo geometric transformations allowing them to be fitted perfectly into the current image displayed on the screen so as to correspond as closely as possible to a component to be inspected.

In practice, the control method may comprise acquiring at least one image of the component or components to be inspected, by means of a camera integrated into the portable electronic terminal, and transmitting the image or images from the portable electronic terminal to an external server.

The operator may thus film or photograph a component of the aircraft by means of the portable electronic terminal. The image or images acquired in this way may then be transmitted to the external server, for example via a wireless communication protocol, in order to be able to carry out analyzes based on these images.

According to one embodiment of the disclosure compatible with the preceding embodiments, the control method may comprise realigning the graphic interface component or components in relation to the at least one current image, the realignment being carried out by means of at least two electromagnetic signal transmitters arranged on the aircraft, the transmitters allowing electromagnetic signals to be transmitted over 360 degrees around the aircraft.

Such electromagnetic signal transmitters therefore make it possible to accurately identify the position of the portable electronic terminal in relation to the aircraft.

Such transmitters may, for example, be arranged at or in the vicinity of the different stations to be inspected and, for example, in the vicinity of a door jamb, a tail boom, a nose or indeed an engine cowl.

These transmitters may be powered by means of a power line or a dedicated rechargeable battery. Moreover, such transmitters may advantageously be positioned inside the aircraft.

The transmitters may further use a low-power wireless communication protocol like that deployed, for example, on the network of the company “Sigfox” or indeed an RFID (Radio Frequency Identification) protocol, for example by using an RFID tag arranged on the portable electronic terminal.

Alternatively, or additionally, the realignment may also be carried out by means of other recognition systems arranged on the aircraft. Such other systems may further be used in addition to improve the accuracy of measurement of the relative position of the portable electronic terminal in relation to the aircraft or indeed in the event of a failure of one of the electromagnetic signal transmitters. Moreover, the accuracy of measurement may be improved by combining the position information from the at least two electromagnetic signal transmitters with the position information from another additional system.

Advantageously, the control method may comprise carrying out an additional acquisition of images of said at least one component to be inspected, the additional acquisition being carried out by means of a remote camera arranged on another aircraft in flight, the additional acquisition of images allowing the graphic interface component or components to be realigned in relation to said at least one current image.

Such another aircraft may not have a pilot and may, for example, be a multirotor drone. This drone may perform a flight phase around the aircraft and communicate with the portable electronic terminal in order to transmit the images from the remote camera.

Such an additional acquisition of images may allow the pilot to remain sat in the cockpit of the aircraft, or elsewhere, and to then display these real images of the aircraft on the screen of the portable electronic terminal. Moreover, one or more aircraft may be used simultaneously to acquire images, for example at several control stations at the same time. Optionally, as a result of these images displayed on the screen, the operator may, if in doubt, choose to go and visually control one or more components to be inspected of one or more control stations.

According to another embodiment of the disclosure compatible with the preceding embodiments, for each of the control stations of the plurality of control stations, the control method may comprise the following steps:

determining a piece of status data representative of a current status of said at least one control station, the current status being chosen from the group comprising an all validated status corresponding to the validated state of each of the inspected components, a non-validated status corresponding to the non-validated state of at least one of the inspected components, an inspection underway status of a control station and an inspection not carried out status of a control station;

storing the piece of status data; and

displaying the piece of status data on the screen.

In the same way as with the piece of state data of an instruction, such a piece of status data may also be displayed by using a predetermined color code. According to one embodiment, the color representing the control station on the screen may vary depending on the piece of status data of each station.

Thus, when the current status of a control station is the all validated status, the color of the station may be green. When the current status of a control station is the non-validated status, the color of this station may be red.

When the current status of a control station is the inspection underway status, the color of the station may be orange. When the current status of a control station is the inspection not carried out status, the color of this station may be blue.

When the current state of an instruction is the inspection not carried out state, the background color of this instruction may be blue.

According to one advantageous example, the control method may comprise displaying, on the screen, a piece of position data representative of the current control station.

Such a piece of position data may, for example, comprise a circular dial provided with several points equally spaced in azimuth around an aircraft shown from above or below on the screen. One of the points corresponding to the current control station may be displayed, for example, in a different color to that corresponding to the other points.

Another object of the present disclosure is a system for controlling a plurality of control stations of an aircraft, each control station comprising at least one component to be inspected by an operator.

According to the disclosure, such a control system is remarkable in that it comprises:

a portable electronic terminal carried by the operator, the portable electronic terminal comprising a screen and a selection interface;

a sensor for determining a current position of the portable electronic terminal in relation to the aircraft; an identification unit for identifying a current control station from the plurality of control stations, the current control station being identified depending on the current position of the portable electronic terminal in relation to the aircraft;

a component for determining at least one current image of the aircraft representative of the current control station, the determination component being configured to display the current image or images of the aircraft on the screen;

a storage unit for storing a three-dimensional model of the aircraft, the model comprising at least one graphic interface component corresponding to said at least one component to be inspected of the current control station; and a processing unit configured to display the graphic interface component or components in overlay on the current image on the screen, and in that the selection interface allows a result relating to an inspection of said at least one component to be selected, the result corresponding to a validated state or a non-validated state of said at least one inspected component, this result being stored in a memory.

In other words, such a system for controlling a plurality of control stations makes it possible to identify, by means of the sensor, the current relative position of the portable electronic terminal in relation to the aircraft.

Depending on this current position of the portable electronic terminal, the identification unit deduces that is the current control station. Such a current control station may, for example, be the control station that is the shortest distance from the portable electronic terminal.

Optionally, when the operator selects the validated state of the only component of a control station, or of all of the components of a control station, the identification unit may automatically identify the next control station according to a predefined order and stored as being the new current control station.

The component for determining at least one current image may then choose and display a current image of the aircraft on the screen corresponding to this current control station.

Moreover, the three-dimensional model of the aircraft may in particular be chosen as being a virtual reality or indeed augmented reality model.

The processing unit is moreover configured to display the graphic interface component or components, optionally performing a cropping operation in order to make this or these graphic interface components correspond with the current displayed image.

The control system may, for example, serve as a tool to support the training of operators, improving the ergonomics of the control of the different components to be inspected.

According to one advantageous embodiment, the identification unit, the component for determining at least one current image and the processing unit may also be arranged on the portable electronic terminal. Moreover, the identification unit, the component for determining at least one current image and the processing unit may be formed by a single computer or by several computers connected with each other in order to communicate.

Moreover, the identification unit, the component for determining at least one current image and the processing unit may, for example, each respectively comprise at least one processor and at least one memory, at least one integrated circuit, at least one programmable system, or at least one logic circuit, these examples not limiting the scope given to the expressions “identification unit”, “component for determining at least one current image” and “processing unit”. The term “processor” may refer equally to a central processing unit (CPU), a graphics processing unit (GPU), a digital signal processor (DSP), a microcontroller, etc.

Moreover, the selection interface of the portable electronic terminal may, for example, be a pointing device, a keyboard or indeed a touch panel superposed on the screen. The portable electronic terminal may, for example, be formed by a computer, a tablet or a smartphone.

Advantageously, such a control system may comprise a device for determining and displaying, on the screen, at least one instruction corresponding to said at least one component to be inspected of the current control station, the instruction or instructions being stored in another memory, the screen being configured to display the instruction or instructions, the selection device of the portable electronic terminal allowing the operator to select the instruction or instructions.

Such a device for determining and displaying at least one instruction therefore makes it possible to list, for example in a table or column, all the instructions corresponding to the components to be inspected for a given control station.

In practice, the portable electronic terminal may comprise the memory, the other memory and the storage unit.

Therefore, the portable electronic terminal can be used to store the result corresponding to a validated state or a non-validated state of said at least one inspected component, the instruction or instructions to be carried out in order to inspect the component or components, and the three-dimensional model of the aircraft.

The portable electronic terminal may optionally also be used to store the piece or pieces of state data representative of the current state of each instruction, and the piece or pieces of status data representative of a current status of each control station.

According to another advantageous embodiment, the sensor for determining a current position may comprise at least two electromagnetic signal transmitters arranged on the aircraft, the transmitters allowing electromagnetic signals to be transmitted over 360 degrees around the aircraft.

Such electromagnetic signal transmitters may be arranged, for example, at or in the vicinity of each of the control stations and/or be distributed over the aircraft in order to cover all the control stations.

In practice, the sensor for determining a current position may comprise a receive antenna picking up the electromagnetic signals, the receive antenna being arranged on the portable electronic terminal, the identification unit being configured to analyze the electromagnetic signals and identify the current control station.

Therefore, the electromagnetic signals transmitted by the transmitters are picked up by the receive antenna, then possibly transmitted to the identification unit, which can deduce the current control station from them.

According to another embodiment of the disclosure compatible with the preceding embodiments, the processing unit may comprise a realignment unit configured pour realign the graphic interface component or components in relation to said at least one current image.

Such a realignment unit is thus interfaced with the processing unit configured to display the graphic interface component or components. The processing unit configured to display the graphic interface component or components and the realignment unit may optionally each comprise one or more common computers or indeed be formed by a single multitasking computer.

According to one advantageous embodiment compatible with the preceding embodiments, the processing unit may be arranged totally or partially in the portable electronic terminal.

### BRIEF DESCRIPTION OF THE DRAWINGS

The disclosure and its advantages appear in greater detail in the context of the following description of embodiments given by way of illustration and with reference to the accompanying figures, in which:

FIG. 1 is a schematic diagram showing a control system according to the disclosure;

FIG. 2 shows a first current image of an aircraft;

FIG. 3 shows a perspective view of a first variant of a portable electronic terminal;

FIG. 4 shows a perspective view of a second variant of a portable electronic terminal;

FIG. 5 shows a second current image of an aircraft;

FIG. 6 shows said second current image of an aircraft supplemented with instructions;

FIG. 7 shows a first screen portion displayed on a portable electronic terminal;

FIG. 8 shows a second screen portion displayed on a portable electronic terminal;

FIG. 9 shows a third screen portion displayed on a portable electronic terminal at a first instant of a control method;

FIG. 10 shows a third screen portion displayed on a portable electronic terminal at a second instant of a control method;

FIG. 11 shows a third screen portion displayed on a portable electronic terminal at a third instant of a control method; and

FIG. 12 is a logic diagram showing the steps of a control method according to the disclosure.

### DETAILED DESCRIPTION

Elements that are present in more than one of the figures are given the same references in each of them.

As already indicated, the disclosure relates to a method and a system for controlling a plurality of control stations of an aircraft.

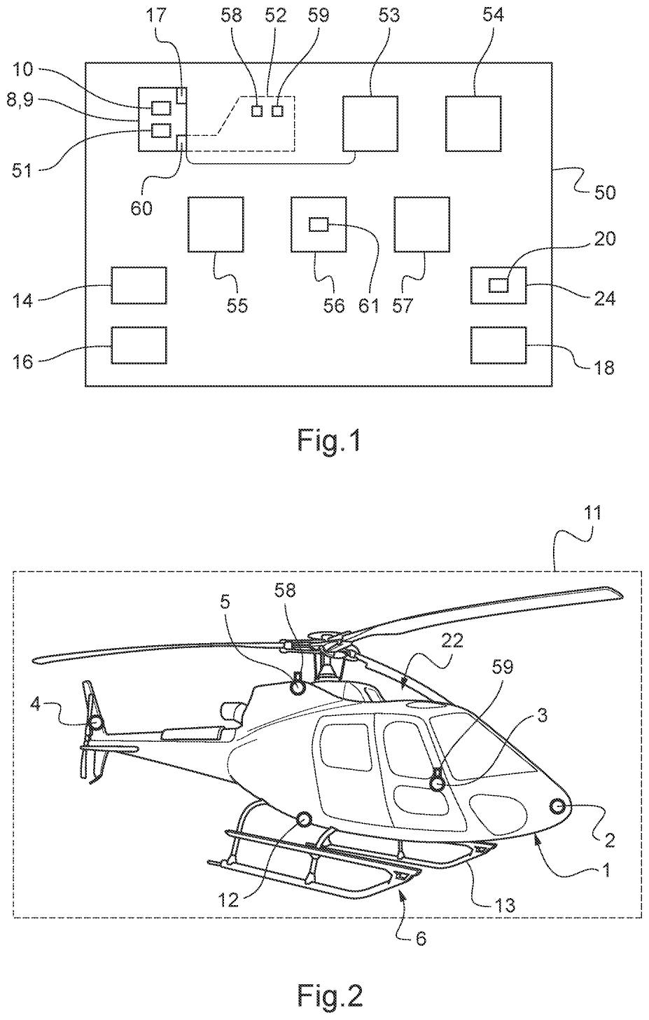

As shown in FIG. 1, the control system 50 comprises a portable electronic terminal 8, 9 carried or held by an operator such as a pilot of the aircraft or a technician. Moreover, such a portable electronic terminal 8, 9 comprises a screen 10 and a selection interface 51 having, for example, a pointing device, a keyboard or a touch panel superposed on the screen 10.

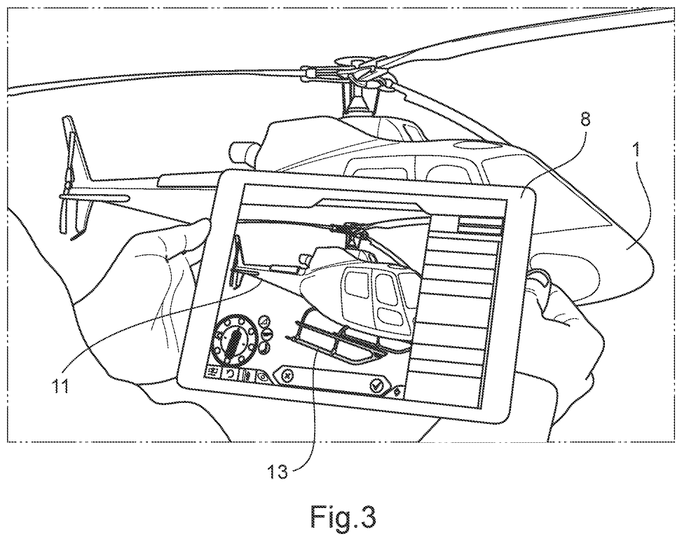

According to a first variant as shown in FIG. 3, the portable electronic terminal 8 may thus be formed by a tablet computer.

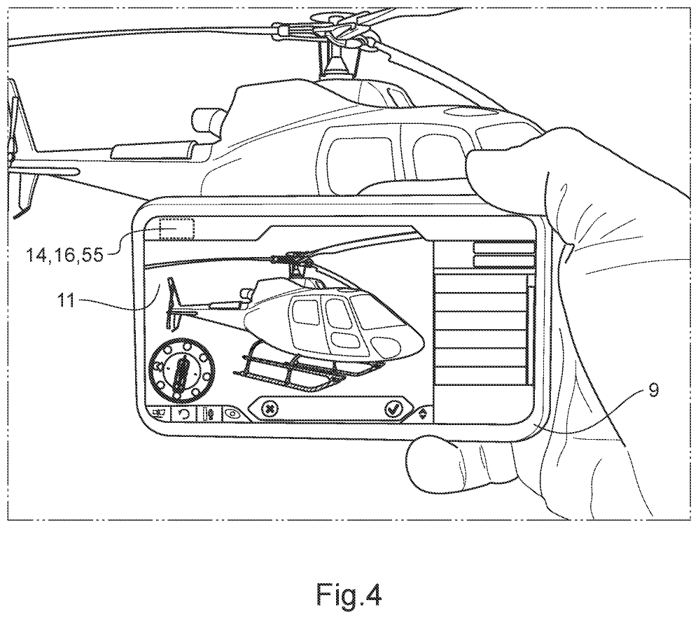

According to a second variant as shown in FIG. 4, the portable electronic terminal 9 may also be formed by a smartphone.

Moreover, as shown in FIG. 2, an aircraft 1 may have a plurality of control stations 2, 3, 4, 5, 12, 13 each comprising at least one component 6, 7 to be inspected by an operator.

The control system 50 comprises a sensor 52 for determining a current position of the portable electronic terminal 8, 9 in relation to the aircraft 1.

Such a sensor 52 for determining a current position may, for example, comprise at least two electromagnetic signal transmitters 58, 59 positioned on the aircraft 1. Such transmitters 58, 59 therefore allow electromagnetic signals to be transmitted all around the aircraft 1 in order to cover all of the movements of the operator and his or her portable electronic terminal 8, 9.

Moreover, the sensor 52 may also comprise a receive antenna 60 designed to receive the electromagnetic signals transmitted by the transmitters 58, 59. The receive antenna 60 is then advantageously integrated into or secured to the portable electronic terminal 8, 9.

Moreover, the control system 50 comprises an identification unit 53 configured to identify a current control station 12, 22 from the plurality of control stations 2, 3, 4, 5, 12, 13.

Such an identification unit 53 may thus be connected to or integrated into the portable electronic terminal 8, 9. The identification unit 53 may thus be configured to analyze the electromagnetic signals received by the antenna 60 and identify the current control station 12, 22.

Moreover, the control system 50 also comprises a component 54 for determining at least one current image 11, 21 of the aircraft 1 representative of the current control station 12, 22. Such a determination component 54 can therefore be used to display the current image or images 11, 21 of the aircraft 1 on the screen 10. The determination component 54 may thus be connected to the portable electronic terminal 8, 9 by wired or wireless means. Alternatively, the determination component 54 may also be integrated into the portable electronic terminal 8, 9.

Moreover, the control system 50 comprises a storage unit 55 that can be used to store a three-dimensional model of the aircraft 1. Such a model has at least one graphic interface component 13, 23 corresponding to the component 6, 7 to be inspected of the current control station 12, 22. The storage unit 55 may thus be connected to the portable electronic terminal 8, 9 by wired or wireless means. Alternatively, the storage unit 55 may also be integrated into the portable electronic terminal 8, 9.

Furthermore, the control system 50 comprises a processing unit 56 configured to display the graphic interface component or components 13, 23 in overlay on the current image or images 12, 22 on the screen 10. The processing unit 56 may thus be connected to the portable electronic terminal 8, 9 by wired or wireless means. Alternatively, the processing unit 56 may also be integrated into the portable electronic terminal 8, 9.

Moreover, the identification unit 53, the component 54 for determining at least one current image and the processing unit 56 may, for example, respectively each comprise at least one computer.

As shown in FIGS. 2 to 4, a graphic interface component 13 in wireframe form is overlaid on a landing gear of the aircraft 1 contained in the current image 11.

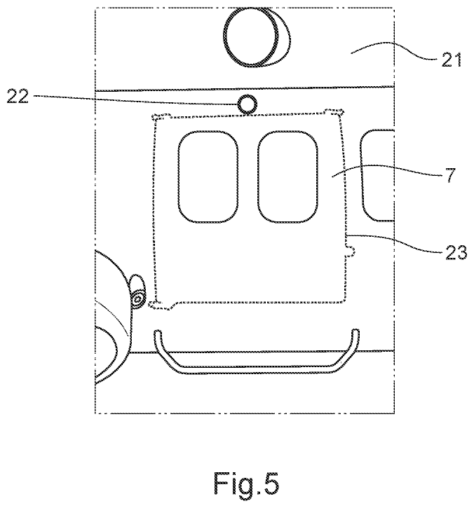

As shown in FIG. 5, a graphic interface component 23 in rectangular form is overlaid on a door of the aircraft 1 contained in the current image 21.

Moreover, as shown in FIG. 7, the selection interface 51 of the portable electronic terminal 8, 9 allows the operator to select a result relating to an inspection of the component or components 6, 7.

Such a result may correspond to an instruction validated state, for example, if the operator slides a finger over a selection region 511 from left to right.

Alternatively, the result may correspond to an instruction not validated state, for example if the operator slides a finger over the selection region 511 from right to left.

Once the result has been selected with the selection interface 51, the result is stored in a memory 14 of the control system 50.

Moreover, the control system 50 may comprise a device for determining and displaying, on the screen 10, at least one instruction 571, 572 corresponding to a component 6, 7 to be inspected of the current control station 12, 22. The determination and display device 57 may thus be connected to the portable electronic terminal 8, 9 by wired or wireless means. Alternatively, the determination and display device 57 may also be integrated into the portable electronic terminal 8, 9.

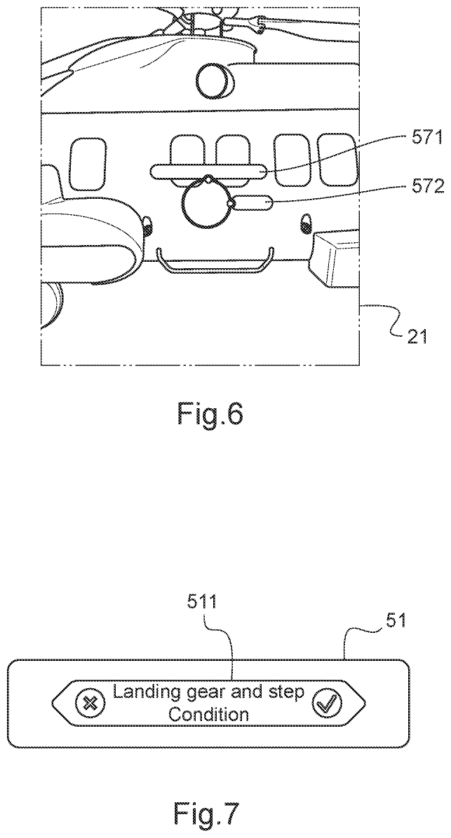

As shown in FIG. 6, such an instruction 571, 572 may be displayed on the screen 10 and overlaid on the current image comprising a door of the aircraft 1 corresponding, in this example, to the component 7 to be inspected. The selection device 51 of the portable electronic terminal 8, 9 thus allows the operator to select one of the displayed instructions.

This or these instructions 571, 572 may be stored in another memory 16. Such another memory may be separate from or alternatively merged with the memory 14. Advantageously, the memory 14, the other memory 16 and the storage unit 55 may be integrated into the portable electronic terminal 8, 9.

As shown in FIGS. 3, 4 and 8, the device 57 for determining and displaying at least one instruction 571, 572 may in particular allow all the instructions corresponding to the components 6, 7 to be inspected for a given control station to be classified and listed, for example in a table or column 573.

Moreover, a current state 151 of the instruction or instructions 571, 572 may be chosen from the group comprising an instruction validated state, an instruction not validated state, an instruction forgotten state and an instruction not carried out state.

A background or a fill type of each cell of the column 573 then allows the current state 151 of each of the instructions 571, 572 to be visually identified.

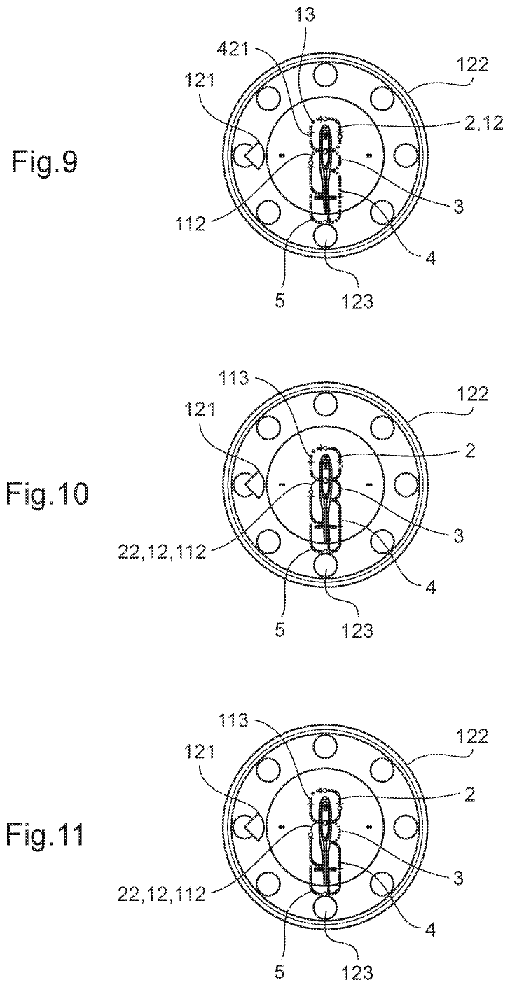

As shown in FIGS. 9 to 11, the screen 10 may also display a piece of position data 121 representative of the current control station 12, 22.

Such a piece of position data 121 may, for example, comprise a circular dial 122 provided with several points 123 equally spaced in azimuth around an aircraft shown from above or below on the screen 10. One of the points 123 corresponding to the current control station 12, 22 may be displayed, for example, in a different color to that corresponding to the other points 123.

Moreover, FIGS. 9 to 11 also allow a piece of status data representative of a current status 421 of each control station 2, 3, 4, 5, 112, 113 to be displayed. Such a current status 421 is chosen from the group comprising an all validated status corresponding to the validated state of the control station 2, 3, 4, 5, 112, 113, a non-validated status corresponding to the non-validated state of the control station 2, 3, 4, 5, 112, 113, an inspection underway status of the control station 2, 3, 4, 5, 112, 113 and an inspection not carried out status of the control station 2, 3, 4, 5, 112, 113.

For example, in FIG. 9, all the control stations 2, 3, 4, 5, 112, 113 have not yet been inspected. Therefore, the type or the color of the lines representative of the different control stations 2, 3, 4, 5, 112, 113 and surrounding the aircraft, shown from above, are identical. These lines may be colored blue and are represented, for example, by dash-dotted lines in FIG. 9.

However, in FIG. 10, the current status of the control stations 2, 3, 4, 5 is the all validated status; the color of these lines may, for example, be green and represented by bold solid lines in FIG. 10. The current status of the control station 112 is the inspection underway status; the color of this line may, for example, be orange and represented by a thin solid line in FIG. 10. The control station 112 then corresponds to the current control station 12, 22.

According to FIG. 11, the current status of the control stations 2, 4, 5 is the all validated status. The current status of the control station 3 is the non-validated status; the color of this station may be red and represented by a dotted line in FIG. 11.

The current status of the control station 112 is the inspection underway status; the color of this line may, for example, be orange and represented by a thin solid line in FIG. 10. The control station 112 then corresponds to the current control station 12.

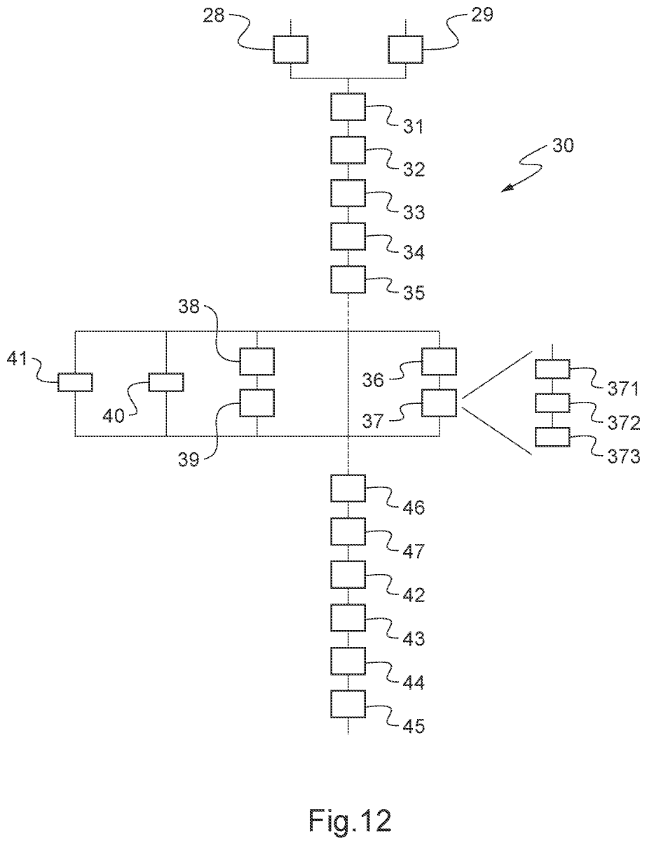

As shown in FIG. 12, the disclosure also relates to a control method 30 that comprises determining 31 a current position of the portable electronic terminal 8, 9 in relation to the aircraft 1, identifying 32, with the portable electronic terminal 8, 9, a current control station 12, 22 from the different control stations 2, 3, 4, 5, 112, 113 and determining at least one current image 11, 21 of the aircraft 1 representative of the current control station 12, 22.

Moreover, such a determination 33 of at least one current image 11, 21 may be conditioned by selecting 28 a virtual reality operating mode or selecting 29 an augmented reality operating mode.

When the virtual reality operating mode is selected 28, at least one current image 11, 21 of the aircraft 1 is determined 33 by selecting the current image 11, 21 from a plurality of stored images of the aircraft 1.

However, when an augmented reality operating mode is selected 29, at least one current image 11, 21 of the aircraft 1 is determined 33 by means of a camera 17 integrated into the portable electronic terminal 8, 9, acquiring images of the aircraft 1 in real time.

Moreover, such a control method 30 then comprises displaying 34, on the screen 10 of the portable electronic terminal 8, 9, this or these current images 11, 21 of the aircraft 1, and displaying 35, on the screen 10, at least one graphic interface component 13, 23 corresponding to a component 6, 7 to be inspected of the current control station 12, 22. Such a display operation 34 is carried out by overlaying the graphic interface component or components 13, 23 on a current image 11, 21.

For example, and as shown in FIGS. 2 to 4, a graphic interface component 13 may be overlaid on the landing gear forming a component 6 of the aircraft 1. According to another example shown in FIG. 5, a graphic interface component 23 may be overlaid on the door of the aircraft forming another component 7 of the aircraft 1.

The control method 30 then comprises selecting 46 the result relating to the inspection of the component 6, 7 on the portable electronic terminal 8, 9, and storing it 47 in the memory 14, this result corresponding to a validated state or a non-validated state of the inspected component 6, 7.

The method 30 may also comprise determining and displaying 36, on the screen 10, at least one instruction 571, 572 corresponding to the component 6, 7 to be inspected of the current control station 12, 22 and selecting 37 the instruction or instructions 571, 572, by means of the portable electronic terminal 8, 9, by the operator.

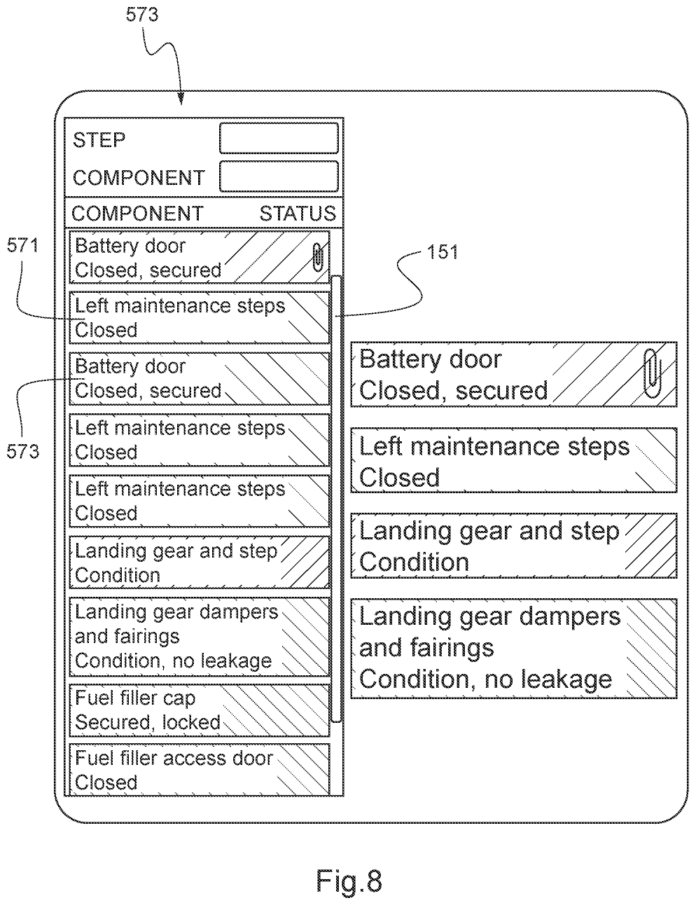

Optionally, for each of the instructions 571, 572, the control method 30 may comprise determining 371 a piece of state data representative of the current state 151 of the instructions 571, 572 as shown previously in FIG. 8. The control method may then comprise storing 372 the piece of state data and displaying 373 this piece of state data on the screen 10.

Advantageously, the control method 30 may also comprising acquiring 38 at least one image of the component 6, 7 to be inspected, by means of a camera 17 integrated into the portable electronic terminal 8, 9, and transmitting 39 the image or images from the portable electronic terminal 8, 9 to an external server 18 shown in FIG. 1.

Moreover, the control method 30 may comprise realigning 40 the graphic interface component or components 13, 23 in relation to the current image 11, 21. Such a realignment operation 40 may be carried out by means of the two electromagnetic signal transmitters 58, 59 arranged on the aircraft 1.

According to another variant of the control method 30, such a control method 30 may also comprise carrying out an additional acquisition 41 of images of the component 6, 7 to be inspected. In this case, the control system 50 may comprise another aircraft 24, such as a drone, equipped with a remote camera 20 allowing the additional images of the component 6, 7 to be inspected to be acquired.

This additional acquisition operation 41 may be carried out by means of the remote camera 20 arranged on the other aircraft 24. Such an additional acquisition 41 of images may, in particular, allow the graphic interface component 13, 23 to be realigned in relation to the current image 11, 21.

According to one embodiment compatible with the preceding embodiments, for each of the control stations 2, 3, 4, 5, 112, 113, the control method 30 may comprise determining 42 a piece of status data representative of the current status 421 of the control station 2, 3, 4, 5, 112, 113, storing 43 the piece of status data and displaying 44 the piece of status data on the screen 10.

As already shown in FIGS. 9 to 11, the control method 30 may comprise displaying 45, on the screen 10, a piece of position data 121 representative of said current control station 12, 22.

Naturally, the present disclosure is subject to numerous variations as regards its implementation. Although several embodiments are described above, it should readily be understood that it is not conceivable to identify exhaustively all the possible embodiments. It is naturally possible to envisage replacing any of the means described by equivalent means without going beyond the ambit of the present disclosure.

What is claimed is:

1. A method for controlling a plurality of control stations of an aircraft, each control station comprising at least one component to be inspected by an operator,
wherein the control method comprises the following steps:
determining a current position of a portable electronic terminal in relation to the aircraft, the portable electronic terminal being carried by the operator;
identifying, with the portable electronic terminal, a current control station from the plurality of control stations, the identifying step depending on the current position of the portable electronic terminal in relation to the aircraft;
determining at least one current image of the aircraft representative of the current control station;
displaying, on a screen of the portable electronic terminal, the at least one current image of the aircraft;
displaying, on the screen, at least one graphic interface component corresponding to the at least one component to be inspected of the current control station, the at least one graphic interface component being displayed in overlay on the at least one current image; and
selecting a result relating to an inspection of the at least one component on the portable electronic terminal and storing the result relating to an inspection of the at least one component in a memory, the result corresponding to a validated state or a non-validated state of the at least one component inspected.

2. The method according to claim 1,
wherein the method comprises the following steps:
determining and displaying, on the screen, at least one instruction corresponding to the at least one component to be inspected of the current control station, another memory storing, for each component, at least one of the at least one instruction; and
selecting the at least one instruction, by means of the portable electronic terminal, by the operator.

3. The method according to claim 2,
wherein, for each of the at least one instruction, the control method comprises the following steps:
determining a piece of state data representative of a current state of the at least one instruction of the at least one component inspected, the current state being chosen from the group comprising an instruction validated state, an instruction not validated state, an instruction forgotten state and an instruction not carried out state;
storing the piece of state data; and
displaying the piece of state data on the screen.

4. The method according to claim 1,
wherein the control method comprises selecting a virtual reality operating mode, the determination of at least one current image of the aircraft being carried out by selecting the at least one current image from a plurality of stored images of the aircraft.

5. The method according to claim 1,
wherein the control method comprises selecting an augmented reality operating mode, the determination of at least one current image of the aircraft being carried out by means of a camera integrated into the portable electronic terminal.

6. The method according to claim 1,
wherein the control method comprises acquiring at least one image of the at least one component to be inspected, by means of a camera integrated into the portable electronic terminal, and transmitting the at least one image from the portable electronic terminal to an external server.

7. The method according to claim 1,
wherein the control method comprises realigning the at least one graphic interface component in relation to the at least one current image, the realignment being carried out by means of at least two electromagnetic signal transmitters arranged on the aircraft, the at least two transmitters allowing the electromagnetic signals to be transmitted over 360 degrees around the aircraft.

8. The method according to claim 1,
wherein the control method comprises carrying out an additional acquisition of images of the at least one component to be inspected, the additional acquisition being carried out by means of a remote camera arranged on another aircraft in flight, the additional acquisition of images allowing the at least one graphic interface component to be realigned in relation to the at least one current image.

9. The method according to claim 1,
wherein, for each of the control stations of the plurality of control stations, the control method comprises the following steps:
determining a piece of status data representative of a current status of the at least one control station, the current status being chosen from the group comprising an all validated status corresponding to the validated state of each of the inspected components, a non-validated status corresponding to the non-validated state of at least one of the at least one component inspected, an inspection underway status of the at least one control station and an inspection not carried out status of the at least one control station;
storing the piece of status data; and
displaying the piece of status data on the screen.

10. The method according to claim 1,
wherein the control method comprises displaying, on the screen, a piece of position data representative of the current control station.

11. A system for controlling a plurality of control stations of an aircraft, each control station comprising at least one component to be inspected by an operator,
wherein the control system comprises:
a portable electronic terminal carried by the operator, the portable electronic terminal comprising a screen and a selection interface;
a sensor for determining a current position of the portable electronic terminal in relation to the aircraft;
an identification unit for identifying a current control station from the plurality of control stations, the current control station being identified depending on the current position of the portable electronic terminal in relation to the aircraft;
a component for determining at least one current image of the aircraft representative of the current control station, the determination component being configured to display the at least one current image of the aircraft on the screen;
a storage unit for storing a three-dimensional model of the aircraft, the model comprising at least one graphic interface component corresponding to the at least one component to be inspected of the current control station; and
a processing unit configured to display the at least one graphic interface component in overlay on the at least one current image on the screen,
and wherein the selection interface allows a result relating to an inspection of the at least one component to be selected, the result corresponding to a validated state or a non-validated state of the at least one component inspected, the result being stored in a memory.

12. The system according to claim 11,
wherein the control system comprises a device for determining and displaying, on the screen, at least one instruction corresponding to the at least one component to be inspected of the current control station, the at least one instruction being stored in another memory, the screen being configured to display the at least one instruction, the selection device of the portable electronic terminal allowing the operator to select the at least one instruction.

13. The system according to claim 12,
wherein the portable electronic terminal comprises the memory, the other memory and the storage unit.

14. The system according to claim 11,
wherein the sensor for determining a current position comprises at least two electromagnetic signal transmitters arranged on the aircraft, the at least two transmitters allowing the electromagnetic signals to be transmitted over 360 degrees around the aircraft.

15. The system according to claim 14,
wherein the sensor for determining a current position comprises a receive antenna picking up the electromagnetic signals, the receive antenna being arranged on the portable electronic terminal, the identification unit being configured to analyze the electromagnetic signals and identify the current control station.

16. The system according to claim 11,
wherein the processing unit comprises a realignment unit configured to realign the at least one graphic interface component in relation to the at least one current image.
